(19) United States
(12) Patent Application Publication
(10) Pub. No.: US 2006/0280115 A1
(43) Pub. Date: Dec. 14, 2006

(54) Method of controlling a papr using a walsy code allocation technique in a cdma-2000 system

(75) Inventor: Jung Kyu Sun, Jeollanam-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/560,478

(22) PCT Filed: Jul. 26, 2004
(86) PCT No.: PCT/KR04/01881

§ 371 Date: Jul. 31, 2006

(30) Foreign Application Priority Data
Jul. 25, 2003 (KR) 10-2003-0051456

(51) Int. Cl. H04J 11/00; H04B 7/216

(52) U.S. Cl. 370/209; 370/335

(57) ABSTRACT

There is provided a peak to average power ratio (PAPR) control method which efficiently allocates Walsh codes to channels in a CDMA-2000 (Wideband-CDMA) system. Specifically, the method of the present invention comprises the steps of: at a base station controller, requesting a traffic channel allocation to a transmitter of a base station system; at the transmitter, confirming whether or not there exist channels that have been previously allocated; at the transmitter, if there are previously allocated channels, determining whether or not there exist out-of-use channels among the previously allocated channels; and at the transmitter, if there are out-of-use channels, allocating to a new channel the lowest Walsh code among a Walsh code set that is available to be allocated.

### TECHNICAL FIELD

The present invention generally relates to a method of controlling a peak to average power ratio (PAPR) using a Walsh code allocation technique in a CDMA-2000 system. More particularly, the invention is directed to a method capable of improving the efficiency of a power amplifier in a base station system of the CDMA-2000 system by decreasing a PAPR by a proper level through the use of an improved Walsh code allocation algorithm that identifies channels in a transmitter of the base station system.

### BACKGROUND ART

In general, the efficiency of a base station system in a CDMA-2000 telecommunication system such as CDMA-200 system, etc. relies upon a power amplifier formed in a terminal side. As such, the power amplifier, which largely affects the efficiency of the base station system, amplifies a signal transmitted through channel card, IF transmitting/receiving module, and RF transmitting/receiving module. It then transmits the signal to an antenna.

Such power amplifier provides high amplification efficiency below a prescribed power. It fails to amplify a signal over that power, thus lowering the efficiency. Further, the power amplifier that is capable of offering high amplification efficiency even over a higher power is relatively expensive.

Thus, the base station system employs a low price power amplifier and allows the required efficiency to be maintained by eliminating peak value of transmission signal. This decreases the amplification efficiency of the power amplifier in channel card, IF transmitting/receiving module, or RF transmitting/receiving module. This is to improve the defects in the lower price power amplifier or to distort the peak value of the transmission signal in the IF transmitting/receiving module.

However, the method of enhancing the efficiency of the prior art base station system is deficient since it is provided with an extra circuit in IF transmitting/receiving module or RF transmitting/receiving module, thereby undesirably increasing the installation cost of the base station system.

Moreover, the conventional base station system identifies channels by using Walsy code. In other words, each channel is identified in a mobile receiver in such a way that different Walsy codes are allocated to respective channels by using orthogonal characteristics of the Walsy codes.

For instance, if the transmitter of the base station system uses 64 Walsy codes, then allocation of the Walsy codes is made in sequence. Specifically, the 61 Walsy codes (i.e., W₂, W₂, . . . , W₃₁, W₃₃, . . . , W₆₃) are sequentially allocated to their corresponding 61 data (traffic) channels except for overhead channels such as pilot channel W₀, paging channel W₁, and synchronization channel W₃₂. If usage of al the data (traffic) channels has been completed, then those Walsy codes are sequentially allocated back to their respective channels from the beginning.

However, when allocating the Walsy codes using the prior art allocation method, the probability of code combination that allows PAPR of signal, which is relatively high due to the characteristics of the run length of Walsy codes, becomes too large. As a result, the prior art method is disadvantageous in that the efficiency of the power amplifier is degraded when PAPR is relatively high.

### DISCLOSURE OF INVENTION

Technical Problem

The object of the present invention is to provide a PAPR control method using a Walsy code allocation technique in a CDMA-2000 system. The present invention seeks to lower the installation cost of a base station system, while improving the efficiency of a power amplifier by controlling a PAPR value in terms of Walsy code allocation without having to incorporate an extra circuit into the base station system.

Technical Solution

To accomplish the above-mentioned object, there is provided a method of allocating Walsh codes in a CDMA-2000 (Wideband-CDMA) system. The method comprises the steps of: at a base station controller, requesting a traffic channel allocation to a transmitter of a base station system; at the transmitter, confirming whether or not there exist channels that have been previously allocated; at the transmitter, if there are previously allocated channels, determining whether or not there exist out-of-use channels among the previously allocated channels; and at the transmitter, if there are out-of-use channels, allocating to a new channel the lowest Walsh code among a Walsh code set that is available to be allocated.

Advantageous Effects

In accordance with a PAPR control method using a Walsy code allocation technique in a CDMA-2000 system of the present invention, PAPR of a transmission signal can be lowered by allowing the number (i.e., multiple of 8) for differencing the indexes of Walsy codes to have minimum value. By doing so, the efficiency of a power amplifier in a transmitter of a base station system can be significantly improved.

Further, in accordance with the PAPR control method using the Walsy code allocation in a CDMA-2000 system of the invention, the installation cost of the base station system can be lowered since it does not comprise an extra circuit.

### BRIEF DESCRIPTION OF THE DRAWINGS

FIG. 1 shows a diagram representing a forward link of CDMA-2000 in accordance with a preferred embodiment of the present invention.

FIGS. 2 to 5 depict PAPR values according to various Walsy code allocations in CDMA-2000 in accordance with a preferred embodiment of the present invention, respectively.

FIG. 6 illustrates a flow chart for showing a PAPR control method using a Walsy code allocation algorithm in CDMA-2000 system in accordance with a preferred embodiment of the present invention.

### BEST MODE FOR CARRYING OUT THE INVENTION

Hereinafter, details of a PAPR control method using a Walsy code allocation technique in a CVDMA-2000 system in accordance with the present invention will be provided with reference to the accompanying drawings.

To perform the PAPR control method using the Walsy code allocation technique in accordance with the present invention, the transmitter of the base station system effectively allocates Walsh codes to channels. Specifically, if there is a request for a traffic channel allocation from a terminal, the transmitter confirms whether or not there exist channels that have been previously allocated. It then sequentially allocates the Walsy codes to corresponding channels if there are any previously allocated channels. Meanwhile, if there exists out-of-use channels among the previously allocated channels, then the transmitter allocates the lowest Walsh code to a new channel.

Each Walsy code may be constructed from column vector of Hadamard matrix as described in Eq. (1) below:

$$H 1 = [ + 1 ] ; \\ {H}_{2 n} = ( \begin{matrix}{H}_{n} & {H}_{n} \\ {H}_{n} & - {H}_{n}\end{matrix} ) , \\ n \geq 1 \qquad Equation 1$$

Where Wᵢ is a first column of the above matrix.

Walsy function (Wn) is a function that is derived by replacing +1/−1 of Walsy signal by 0/1; and the characteristics of Walsy function may be summarized by Rule 1 below.

Rule 1: if Walsy function is Wᵢ, Wⱼ, mod2sum of Wⱼ, Wⱼ is W(ᵢⱼ), and |i-j| is a multiple of 2^{k}, then value of <ij> is also a multiple of 2^{k}.

Another characteristic of Walsy function is a maximum run length. This run length simply stands for the number of continuous occurrences of 0 or 1. Rule 2, which is provided below, represents the characteristics of run length in Walsy function.

Rule 2: if the index of Walsy function is a multiple of 2^{k}, then the maximum run length of that Walsy function is also a multiple of 2^{k}. If the index of Walsy function is 2^{k}, but not 2^{k+1}, then the maximum run length of that Walsy function is under 2^{k+1}.

For instance, if the index of Walsy function is a multiple of 8, then the maximum run length is also a multiple of 8. In fact, the maximum run length of W₈ is 8, and the maximum run length of W₁₆, W₂₄, etc. is 16. Thus, if the index is a multiple of 4 but not a multiple of 8, then the maximum run length is below 8, and Walsy function that becomes a multiple of 8 has a large run length.

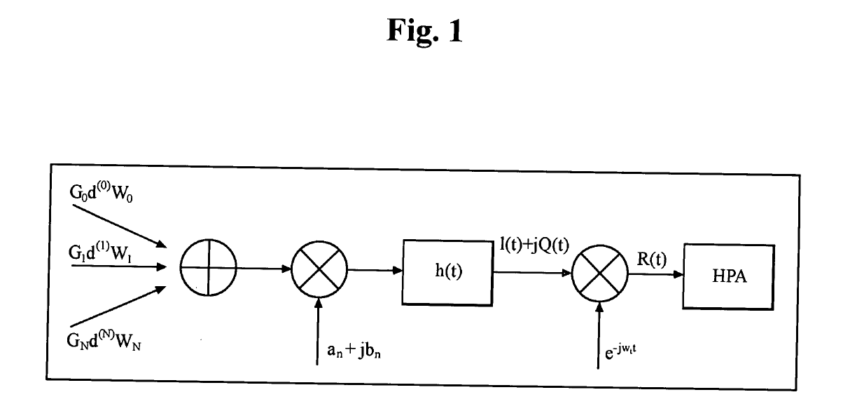

FIG. 1 depicts a forward link of CDMA-2000 and IS95, wherein an input signal R(t) to a power amplifier can be represented by Eq. (2) provided below:
R(t)=I(t)COS(2πF_{c})−Q(t)SIN(2πF_{c}) Equation 2

Where an amplitude of the signal in Eq. (2) may be calculated from Eq. (3) as provided below:
A²=I²(t)−Q²(t=(I(t)+jQ(t))(I(t)−jQ(t)) Equation 3

Where,

$$\begin{matrix}( I ( t ) + jQ ( t ) ) = {\sum }_{{i}_{1} , {n}_{1}} {G}_{{i}_{1}} {d}^{( {l}_{1} )} {W}_{{i}_{1}} [ {n}_{1} ] \cdot ( {a}_{{n}_{1}} + {jb}_{{n}_{1}} ) \cdot h ( t - {n}_{1} T ) \\ = {\sum }_{{i}_{1} , {n}_{1}} {G}_{{t}_{i}} ( {d}_{l}^{( {i}_{1} )} {a}_{{n}_{1}} - {d}_{Q}^{( {i}_{1} )} {b}_{{n}_{1}} ) {W}_{{l}_{1}} [ {n}_{1} ] \cdot h ( t - {n}_{1} T ) + \\ j {\sum }_{{l}_{1} , {n}_{1}} {G}_{{i}_{1}} ( {d}_{Q}^{( {i}_{1} )} {a}_{{n}_{1}} + {d}_{l}^{( {l}_{1} )} {b}_{{n}_{1}} ) {W}_{{i}_{1}} [ {n}_{1} ] \cdot h ( t - {n}_{1} T )\end{matrix}$$

$$\begin{matrix}( I ( t ) - jQ ( t ) ) = {\sum }_{{i}_{2} , {n}_{2}} {G}_{{i}_{2}} {d}^{( {i}_{2} )} {W}_{{i}_{2}} [ {n}_{2} ] \cdot ( {a}_{{n}_{2}} + {jb}_{{n}_{2}} ) \cdot h ( t - {n}_{2} T ) \\ = {\sum }_{{i}_{2} , {n}_{2}} {G}_{{l}_{2}} ( {d}_{l}^{( {i}_{2} )} {a}_{{n}_{1}} - {d}_{Q}^{( {i}_{2} )} {b}_{{n}_{2}} ) {W}_{{l}_{2}} [ {n}_{2} ] \cdot h ( t - {n}_{2} T ) - \\ j {\sum }_{{l}_{2} , {n}_{2}} {G}_{{i}_{2}} ( {d}_{Q}^{( {l}_{2} )} {a}_{{n}_{2}} + {d}_{l}^{( {i}_{2} )} {b}_{{n}_{2}} ) {W}_{{l}_{2}} [ {n}_{2} ] \cdot h ( t - {n}_{2} T )\end{matrix}$$

and, when n₁=n₂ if I(t)±jQ(t) is applied to Eq. (3), then Eq. (3) may be represented as:

$$\begin{matrix}{A}^{2} ( t ) = {I}^{2} ( t ) - {Q}^{2} ( t ) \\ = ( I ( t ) + jQ ( t ) ) ( I ( t ) - jQ ( t ) ) \\ = {\sum }_{{i}_{1} , {i}_{2}} 2 \cdot {G}_{{i}_{1}} \cdot {G}_{{i}_{2}} ( {d}_{l}^{{i}_{1}} {d}_{l}^{{i}_{2}} + {d}_{Q}^{{i}_{1}} {d}_{Q}^{{i}_{2}} ) \\ {\sum }_{{n}_{1}} {W}_{( {i}_{1} , {i}_{2} )} [ {n}_{i} ] {( h ( t - {n}_{1} T ) )}^{2}\end{matrix} \qquad Equation 4$$

As can be seen from Eq. (4), the magnitude of the signal varies depending not on the Walsy signal, but the product of allocated Walsy signal (i.e., W(_{i1,i2})). That is, the probability that the magnitude of the signal is large is high as the run length of W(_{i1,i2}) is large.

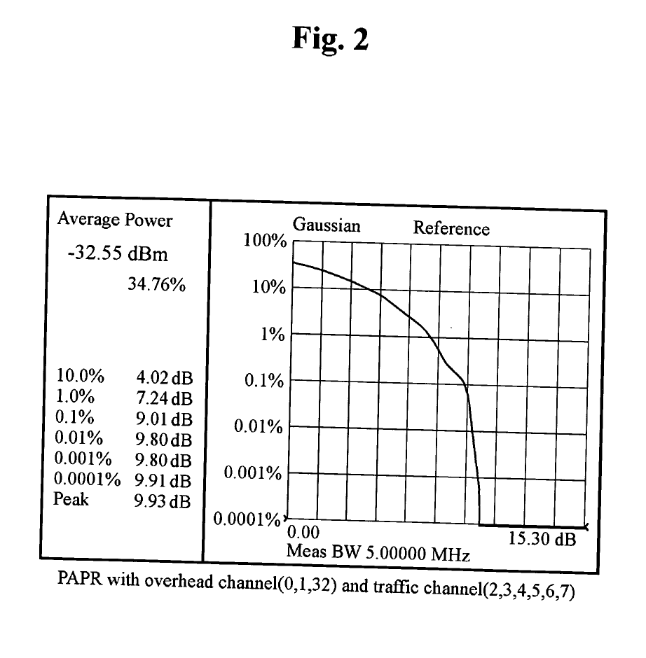

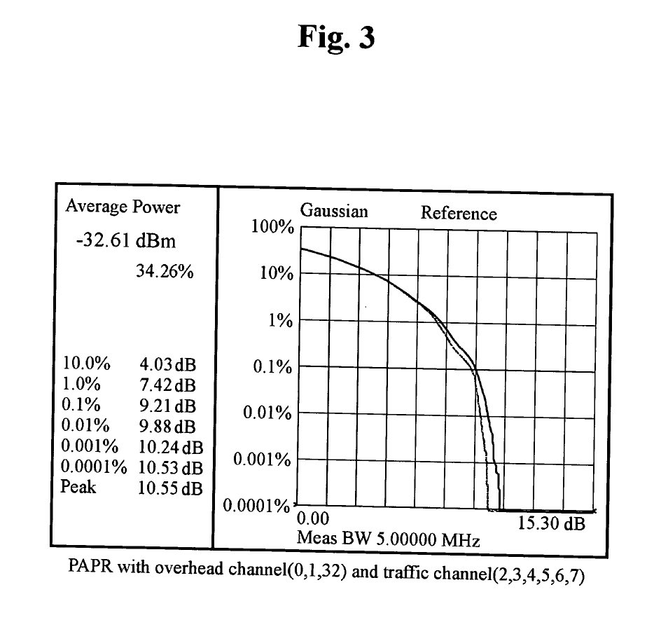

In other words, as shown in FIG. 2, if the PAPR overhead channels are W₀, W₁, W₃₂, and traffic channels are W₂, W₃, W₄, W₅, W₆, W₇, then a multiple of 8 is 1. In such a case, it can be seen that the probability of peak occurrence under 10.00 dB is below 0.0001%. Further, as shown in FIG. 3, if the PAPR overhead channels are W₀, W₁, W₃₂, and traffic channels are W₂, W₃, W₄, W₅, W₆, W₈, then a multiple of 8 is 2. In this case, it can be recognized that the probability of peak occurrence under 10.00 dB is below 0.01%.

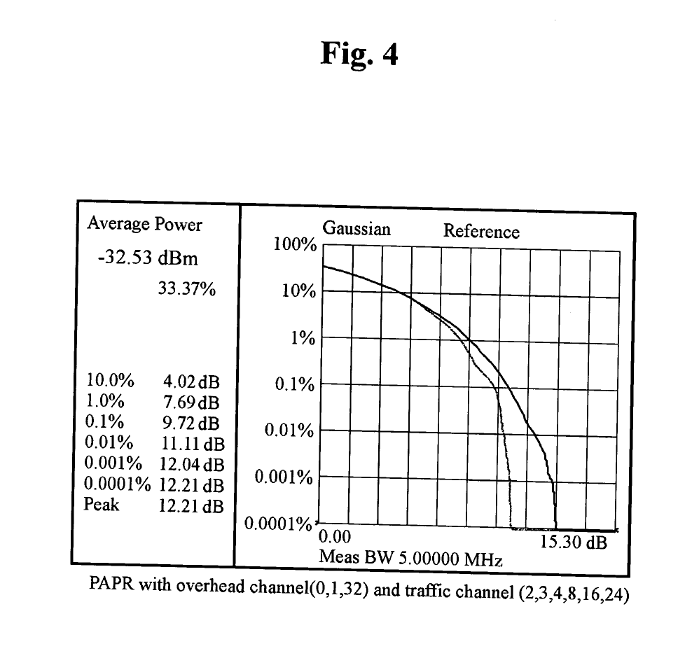

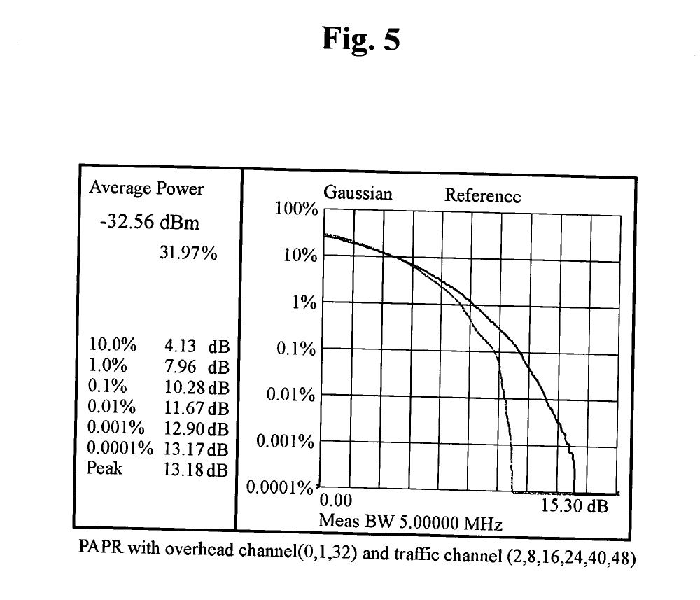

Also, as shown in FIG. 4, if the PAPR overhead channels are W₀, W₁, W₃₂, and traffic channels are W₂, W₃, W₄, W₈, W₁₆, W₃₂, then a multiple of 8 is 10. In such a case, it can be seen that the probability of peak occurrence under 10.00 dB is below 0.1%. Further, as shown in FIG. 5, if the PAPR overhead channels are W₀, W₁, W₃₂, and traffic channels are W₂, W₈, W₁₆, W₂₄, W₃₂, W₆₄, then a multiple of 8 is 21. In this case, it can be understood that the probability of peak occurrence below 10.00 dB is under 1.0%.

As can be seen from the above, since the probability of occurrence of PAPR varies depending on the number of multiple of 8, it is possible to below the probability of occurrence of PAPR by decreasing the size of run length assigned to each channel.

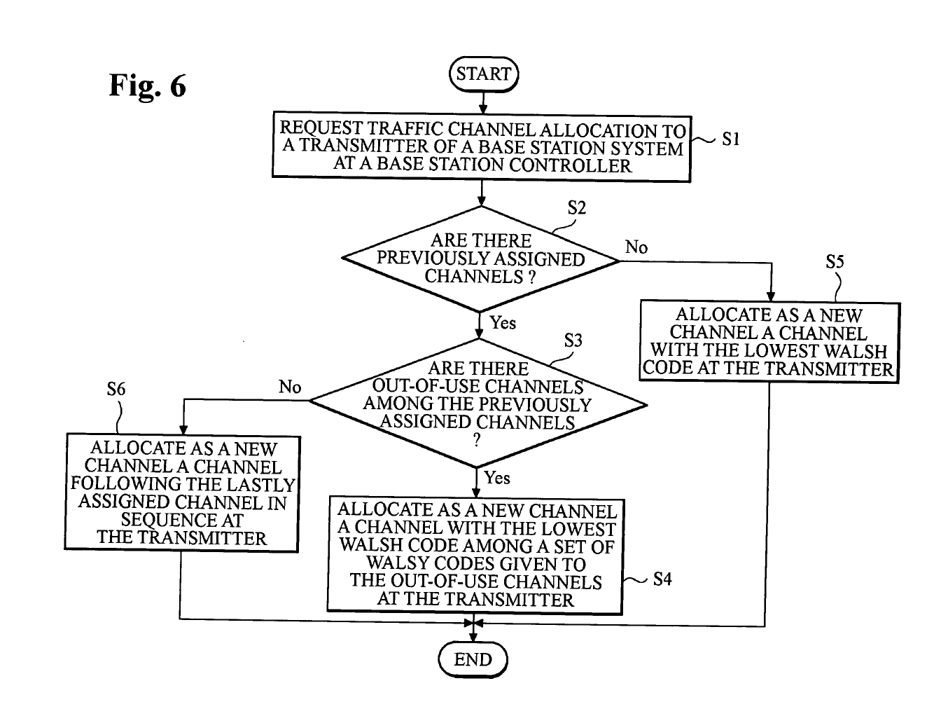

With that in mind, the PAPR control method using the Walsy code avocation technique in the CDMA-2000 system in accordance with the present invention as configured above will be described in detail with reference to FIG. 6 below.

First of all, the transmitter of the base station system allocates channels for pilot signal, paging signal, and synchronization signal. Thereafter, at step S1, the transmitter first receives a request for a traffic channel allocation from a base controller, if any. Then, at step S2, the transmitter confirms whether or not there exist channels that have been previously allocated. At a next step S3, if there are any previously allocated channels, the transmitter determines whether or not there exist out-of-use channels among the previously allocated channels. At step S4, if there are out-of-use channels, the transmitter allocates to a new channel the lowest Walsh code among a Walsh code set that is available to be allocated.

Meanwhile, if there are no channels that have been previously allocated, then at step S5, the transmitter allocates to a new channel the lowest Walsh code among the Walsh code set that is available to be allocated. Further, at a final step S6, if there are no out-of-use channels, the transmitter sequentially allocates to a terminal a channel following the last assigned channel.

While the present invention has been shown and described with respect to the particular external circuit power control method for a reverse data service, it will be apparent to those skilled in the art that many changes and modifications may be made without departing from the scope of the invention as defined in the appended claims and those equivalent thereto.

1. A method of allocating Walsh codes in a CDMA-2000 (Wideband-CDMA) system, said method comprising the steps of:
at a base station controller, requesting a traffic channel allocation to a transmitter of a base station system;
at the transmitter, confirming whether or not there exist channels that have been previously allocated;
at the transmitter, if there are previously allocated channels, determining whether or not there exist out-of-use channels among the previously allocated channels; and
at the transmitter, if there are out-of-use channels, allocating to a new channel the lowest Walsh code among a Walsh code set that is available to be allocated.

2. The method of claim 1, wherein, if there are no channels that have been previously allocated, the transmitter allocates the bwest Walsh code to a new channel.

3. The method of claim 1, wherein, if there are not out-of-use channels, the transmitter allocates to a terminal a channel following the last allocated channel.
